(19) United States
(12) Patent Application Publication
(10) Pub. No.: US 2004/0084445 A1
(43) Pub. Date: May 6, 2004

(54) Microwaveable dish for supporting material which is to be treated in a microwave oven, in particular for foodstuffs to be prepared therein

(76) Inventors: Franciscus Johannes Maria van de Weijer, Oeffelt (NL); Maurits Simon Johannes Maria Driessen, Venray (NL)

Correspondence Address: BLANK ROME LLP, THE FARRAGUT BUILDING SUITE 1000, 900 17TH STREET NW, WASHINGTON, DC, 20006, US

(21) Appl. No.: 10/312,982

(22) PCT Filed: Oct. 29, 2002
(86) PCT No.: PCT/NL02/00687

(30) Foreign Application Priority Data
Oct. 31, 2001 (NL) 1019261
Nov. 16, 2001 (NL) 1019380

(51) Int. Cl. H05B 6/64

(52) U.S. Cl. 219/679

(57) ABSTRACT

Microwaveable dish for supporting material which is to be treated in a microwave oven, in particular for foodstuffs to be prepared therein, which microwaveable dish comprises two or more compartments, a material which influences microwave radiation being incorporated in the wall of at least one of the compartments, allowing microwave radiation to be attenuated, amplified or converted into heat, and the wall comprising a plurality of layers, which microwaveable dish comprises two identical, separately prefabricated self-supporting partial containers, one of the partial containers being at least partially accommodated in the other, and in which microwaveable dish the material which influences microwave radiation is incorporated as a sheet-like material between the two partial containers.

### CROSS-REFERENCE TO RELATED APPLICATION

This is a continuation application of PCT/NL02/00687, filed on 29 Oct. 2002, which PCT application claims priority on NL application number 1019261, filed on 31 Oct. 2001, and NL application number 1019380, filed on 16 Nov. 2001.

### FIELD OF THE INVENTION

The present invention relates firstly to a microwaveable dish for supporting material which is to be treated in a microwave oven, in particular for foodstuffs to be prepared therein, which microwaveable dish comprises two or more compartments, a material which influences microwave radiation being incorporated in the wall of at least one of the compartments, allowing microwave radiation to be attenuated, amplified or converted into heat, while the wall comprises a plurality of layers.

### BACKGROUND OF THE INVENTION

Numerous types of microwaveable dishes with a material which influences microwave radiation in the wall are known in the prior art, the wall consisting of a plurality of layers. A nicrowaveable dish of this type is described, for example, in U.S. Pat. No. 5,126,518.

Furthermore, various microwaveable dishes with a material which influences microwave radiation in their wall, where the wall consists of a plurality of layers but the microwaveable dish includes only one compartment, are known. Examples of these are described in WO-A 92/19511, U.S. Pat. No. 5,053,594 and EP-A 0 350 056.

All the microwaveable dishes which are described in the prior art have the significant drawback of being relatively complicated to produce and therefore expensive. The wall of these microwaveable dishes consists of a layer which imparts strength, a material layer which influences microwave radiation and a protective layer. The protective layer is in all cases a thin foil-like or sheet-like material. During production, this means that in particular the application of the material layer which influences microwave radiation in the wall is difficult, since this material has to be arranged between the protective layer and the layer which imparts strength.

In many cases, this is achieved by applying the protective layer to one of the two out of strength-imparting layer or protecting layer and then combining this combined layer with the other layer. Forming a laminated material layer which influences microwave radiation into a three-dimensional object often leads to damage to the said layer which influences microwave radiation.

Also, the layer which influences microwave radiation is often applied in the prior art by painting, sputtering and the like. These are likewise complicated and expensive techniques. Moreover, layers of this type are undesirable at elevated temperature, on account of the evolution of gases.

Therefore, in the prior art there is no simple reproducible method for producing a microwaveable dish of the type described in the introduction.

Furthermore, U.S. Pat. No. 3,302,632 describes a microwaveable dish with more compartments, it being possible for the compartments to be shielded to different extents for microwave radiation by the presence of metal mesh. A significant drawback of the use of metal mesh is that this material is difficult to shape and machine. Furthermore, when using metal mesh there is a considerable risk of what is known as electrical sparking since there are sharp transitions (for example pointed projections at the edge of the metal mesh), as a result of which electrical fields can be concentrated. High electrical fields generally immediately give rise to sparking in the packaging (if heated in a microwave oven) leading, for example, to local burning of the packaging material. It will be clear that sparking of this type is highly undesirable.

### SUMMARY OF THE INVENTION

It is therefore an object of the present invention to avoid the abovementioned drawbacks and to provide an alternative microwaveable dish which is very easy to produce. To this end, the invention provides a microwaveable dish for supporting material which is to be treated in a microwave oven, in particular for foodstuffs to be prepared therein, which microwaveable dish comprises two or more compartments, a material which influences microwave radiation being incorporated in the wall of at least one of the compartments, allowing microwave radiation to be attenuated, amplified or converted into heat, while the wall comprises a plurality of layers, which microwaveable dish is characterized in that it comprises two identical, separately prefabricated self-supporting partial containers, one of the partial containers being at least partially accommodated in the other, and in that the material which influences microwave radiation is incorporated as a sheet-like material between the two partial containers.

The microwaveable dish according to the invention comprises two prefabricated, identical self-supporting partial containers. These both have sufficient inherent strength for it to be possible for the sheet-like material which influences microwave radiation to be incorporated between them in a simple way while the partial containers are being joined, without the need for complicated lamination steps or the like prior to the joining operation.

In the present description, the term dish is intended to mean any support which is suitable for supporting material which is to be prepared in a microwave oven; consideration may be given to a plate, a bowl, a tray or the like.

The microwaveable dish according to the invention offers the possibility of simultaneously preparing different foodstuffs in a microwave oven, with each foodstuff requiring a different amount of microwave radiation energy for preparation, in the different compartments by suitable positioning of the material which influences microwave radiation in the wall of the microwaveable dish. Moreover, microwave radiation attenuation, amplification or conversion into heat can be set for each compartment as desired.

With the microwaveable dish according to the invention, it is also possible for one compartment to be completely shielded with the aid of the material which influences microwave radiation, so that for example a dessert or salad can be held in this compartment while other foodstuffs are being prepared in the other compartments.

In the microwaveable dish according to the invention, one of the partial containers may comprise two or more separate, loose partial containers.

Although the present invention is in no way limited with regard to the material which is to be treated, the description which follows will discuss only the preparation of foodstuffs. The microwaveable dish according to the invention is also suitable for treating, for example, chemical substances or medicaments and the like in the microwave oven.

In particular, the self-supporting partial containers are at least locally secured to one another after they have been put together. Securing of this nature may be effected, for example, by gluing, welding, (for example thermal, ultrasonic or high-frequency welding) or friction, in order to prevent the partial containers from being able to separate from one another, which is undesirable, during use of the microwaveable dish.

There are no particular limitations imposed with regard to the material used for the partial containers; for example, consideration may be given to cardboard, plastic or the like. The partial containers are preferably self-supporting partial containers. Containers of this type can be produced separately in advance by means of known techniques. Examples of such techniques are injection-moulding, thermoforming, press-moulding, blow-moulding, etc. Examples of suitable temperature-resistant, dimensionally stable plastics are PP, PC, POM/PAC, PA6, PA66, PETP, PBTP, PPS, PSU/PES, FEP, PFA, PEI, mixtures thereof, optionally reinforced by fibres. It is preferable to use PP. It is also possible to use biodegradable polymers.

The sheet-like material which influences microwave radiation is not subject to any particular limitation and, depending on the intended application, can be selected as desired in order, for example, to obtain the effect of attenuating or amplifying microwave radiation. Advantageously, however, the sheet-like material which influences microwave radiation comprises optionally supported aluminium foil. This means that aluminium foil per se is suitable, but so is, for example, aluminium foil supported on paper.

Consideration may also be given to other metals, such as nickel, iron, chromium or tin. Metals of this type are good materials for attenuating microwave radiation. The sheet-like material may also be a supported self-adhesive foil.

The material which influences microwave radiation, in particular if an aluminium foil is used, advantageously has a thickness in the range from 5-100 μm, preferably 6-20 μm, most preferably approx. 7 μm. If a thickness of <5 μm is used, there is a risk of excessive heating; if a thickness of >100 μm is used, the material is less easy to deform.

Examples of materials which amplify microwave radiation are electrically conductive materials of suitable form such that the microwave radiation is focused. By way of example, consideration may be given to a pattern of holes in a material which influences microwave radiation, the distance between and dimension of the holes being selected in such a manner that suitable interference occurs in the radiation. In this context, the pattern of holes may also be selected in such a manner that the foodstuffs which are held in one compartment can be heated differently. The person skilled in the art will understand that the material which influences microwave radiation in this case must be selected in such a manner that sparking with local burning of the microwave dish and/or the foodstuff as a result (or even fusing of the microwaveable dish material to the food present therein) is substantially avoided. For this purpose, the sheet-like material is preferably designed in the form of a “closed conductor”, i.e. the presence of pointed bodies at its edges is avoided as far as possible. It is particularly preferred for the sheet-like material which influences microwave radiation to be rounded at its encircling rim for this purpose.

There are numerous substances which convert microwave radiation into heat, but the most usual of these is water. Water is present in food. Additional heating of the food material which is to be prepared can be obtained by heat conduction or convection of hot air for example by placing certain compartments in communication with one another.

Using an extremely thin metal film allows microwave radiation energy to be dissipated and transferred to the food as heat. The food is on the one hand heated directly by the action of the radiation and on the other hand subjected to an additional heat flux through the foil.

The sheet-like material which influences microwave radiation may also have been suitably deformed prior to joining of the partial containers, so that it fits in a suitable way around the compartments and between the partial containers. In this context, it is possible to make suitable use of what is known as in-mould labelling, in which the sheet-like material which influences microwave radiation is suitably shaped in a mould with the aid of injection-moulding. For this purpose, a small quantity of plastic can be used to impart a predetermined shape to the material which influences microwave radiation in the mould.

In particular, the sheet-like material which influences microwave radiation may also be incorporated in one or more of the partial containers with the aid of in-mould labelling techniques during production of the said partial container.

It will be clear that the sheet-like material which influences microwave radiation can be manipulated in a suitable way in a separate step in a device intended for this purpose, for example with regard to the desired pattern of holes in order to obtain the desired shielding from microwave radiation.

By way of example, meat, potatoes and vegetables can be simultaneously prepared on one dish in a microwave oven using the microwaveable dish according to the invention by selecting the material which influences microwave radiation and which is present in the walls of the compartment in such a manner that the microwave radiation in the compartments is suitably either attenuated, amplified or converted into heat. At the same time, the foodstuffs are prepared at a fixedly set power. It is also possible for the cold drink, salad, dessert or the like to be taken with the meal to be held in a completely shielded compartment. This compartment will not be heated during the preparation of the other foodstuffs.

It is preferable for the microwaveable dish also to comprise a cover. In this context, consideration may be given to a lid or covering sheet or the like.

The microwaveable dish according to the invention will generally comprise a cover, since this ensures improved hygiene. If desired, the lid may be provided with information indicating, for example, the shelf life and the contents. It is preferable for the cover to be selected in such a way that the microwaveable dish is suitable for stacking it.

It is particularly preferable for a material which influences microwave radiation also to be incorporated in the cover, with the result that microwave radiation can be attenuated, amplified or converted into heat. The material which influences microwave radiation is in particular incorporated in the cover in such a manner that it is suitably aligned with specific compartments in order to effect the desired preparatory influencing.

In this case too, the cover may comprise two prefabricated, identical self-supporting partial covers, the material which influences microwave radiation being incorporated as sheet-like material between the two partial covers.

In a particular embodiment, the two partial containers of the microwaveable dish are substantially identical. As a result, it is only necessary to produce one type of partial container, which can then be joined to another identical partial container with suitably designed material which influences microwave radiation incorporated between them.

According to a highly favourable preferred embodiment, at least one compartment is designed in such a manner that the microwave radiation can be attenuated, amplified or converted into heat to different extents at different positions in the said one compartment. In this way, the foodstuffs which are accommodated in one compartment can be heated to different extents. By way of example, a piece of meat over which sauce has been poured may be mentioned. By suitably selecting the shielding, it is possible, according to the invention, for the meat to be heated to a greater extent than the sauce which is present thereon. For this purpose, by way of example, it is possible for the lid not to be provided with material which influences microwave radiation. The person skilled in the art will readily understand that alternatively it is also possible for the wall and/or base of the compartment to have suitable transmission of microwave radiation (for example by selecting an appropriate pattern of holes) in order to achieve the desired effect.

As has already been stated above, the microwave radiation can be substantially completely blocked in at least one compartment. As a result, it is even possible for a cold drink, salad, dessert or the like which is to be taken with the meal to be held in the dish.

It is advantageous for the partial containers to be at least in part positioned at a distance from one another; it is preferable for the partial containers to be positioned at a distance from one another at least over the entire underside of the microwaveable dish. In this way, an air gap which has an insulating action is formed in a surprisingly simple way between the two partial containers. This air gap at least partially prevents conductive heat from flowing from hot compartments to cold compartments by means of heat convection via the support plate of the microwave oven.

It has been found that favourable insulation results are obtained if the distance is at least ≧0.5 mm, preferably ≧1.0 mm, most preferably ≧2.0 mm.

An insulating air gap is provided in a particularly simple way if the partial containers each have an encircling rim and are secured to one another at the encircling rims. It is preferable for the partial containers to be secured to one another at the rims in such a manner that it is impossible for any condensation or other moisture to penetrate into the insulating air gap between the partial containers. This ensures that the insulating action of the air gap is retained.

Furthermore, the invention provides a microwaveable dish according to the invention which contains foodstuffs. A microwaveable dish of this type may, for example, contain a frozen or refrigerated meal.

In addition, the invention provides a partial container which is clearly intended for use in the microwaveable dish according to the invention.

Moreover, the invention provides use of the microwaveable dish according to the invention for preparing foodstuffs in a microwave oven.

Finally, the invention provides a method for producing a microwaveable dish according to the invention, in which one partial container is at least partially introduced into the other partial container with the sheet-like material which influences microwave radiation between them.

Then, the two partial containers are particularly advantageously secured to one another at least locally, preferably only at the encircling rims thereof, so as to form an insulating air gap between the partial containers. This securing of the partial containers to one another may be effected, for example, by gluing or welding or the like.

In particular, the sheet-material which influences microwave radiation is held freely between the partial containers. In other words, gluing, welding or other bonding of the sheet-like material is preferably omitted.

In the method according to the invention, the partial container which is at least partially introduced into the other partial container is used as a type of male die for the sheet-like material which influences microwave radiation, and the other partial container serves as a female die.

### BRIEF DESCRIPTION OF THE DRAWINGS

The invention will be explained in more detail below with reference to the appending drawing, in which:

FIG. 1 shows a perspective view from below of an embodiment of a microwaveable dish according to the invention;

FIG. 2 shows an intermediate phase in the production of the microwaveable dish shown in FIG. 1;

FIG. 3 shows a cross section on line III-III from FIG. 1;

FIG. 4 shows part of a web of sheet, indicating a material part which influences microwave radiation;

FIG. 5 shows a cross section through a cover for the microwaveable dish shown in FIG. 1; and

FIG. 6 shows a plan view of the cover shown in FIG. 5.

### DESCRIPTION OF THE PREFERRED EMBODIMENT

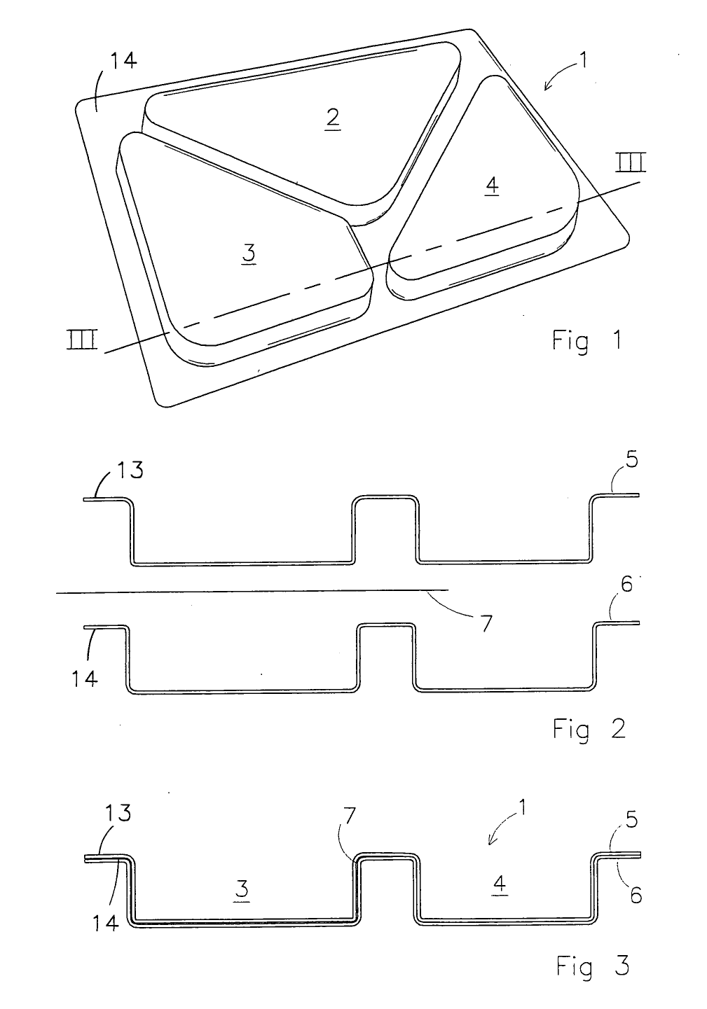

In FIG. 1, 1 denotes the microwaveable dish according to the invention overall, and 2, 3 and 4 denote the different compartments which are present therein.

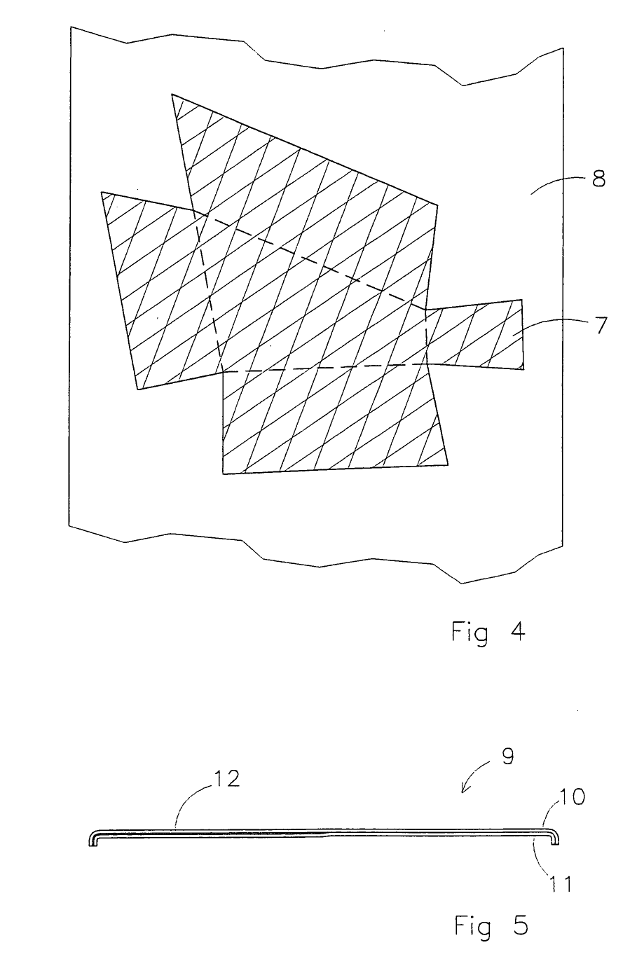

FIG. 2 shows two partial containers 5 and 6 which, together with an approx. 7 μm thick layer of aluminium foil 7 between them, are able to form the microwaveable dish 1. This microwaveable dish 1 is shown in cross section in FIG. 3, which represents the cross section on line III-III from FIG. 1. The partial containers 5 and 6 each have an encircling rim 13 and 14, respectively.

As is clearly apparent from FIG. 2, according to the present invention it is very easy to produce a microwaveable dish with material which influences microwave radiation in its wall, since the partial container 5 can be used as a male die in order to deform the aluminium foil 7 for production of a microwaveable dish as shown in FIG. 3.

FIG. 3 shows the microwaveable dish 1 in the assembled state. The partial containers 5 and 6 have been secured to one another at there rims 13 and 14. In this arrangement it is preferable for there to be an insulating air gap (not shown) between the partial containers 5 and 6 (except at the rims 13 and 14 which have been secured to one another). It has been found that favourable results are obtained if the distance—in particular over the entire underside of the components 2, 3 and 4—between the partial containers 5 and 6 is ≧0.5 mm, preferably greater than or equal to ≧1.0 mm, most preferably ≧2.0 mm.

FIG. 4 shows part of an aluminium foil web 8 in which there is the aluminium foil part 7 which influences microwave radiation and is intended to be incorporated in the wall of the compartment 3.

For this purpose it is possible, for example, to use an aluminium foil web in which the shape of the part 7 has been, for example, partially punched out and this part 7 is still joined to the remainder of the web 8, for example by small bridge connections.

During the production of the microwaveable dish according to the invention, the foil web 8 can be guided between the partial containers 5 and 6. Moving the partial container 5 into the partial container 6 allows the aluminium foil part 7 to be pressed out of the web 8 into the compartment 3 of the partial container 6.

Obviously, the foil parts which influence microwave radiation for different compartments can be supplied simultaneously using one foil web.

FIG. 5 shows, in cross section, an example of a lid 9 which is suitable as a cover for the microwaveable dish 1 shown in FIG. 1. This lid 9 likewise comprises partial lids 10 and 11, between which a sheet-like material 12 which influences microwave radiation is accommodated. In this case, this material 12 is obviously aligned with the compartment 3.

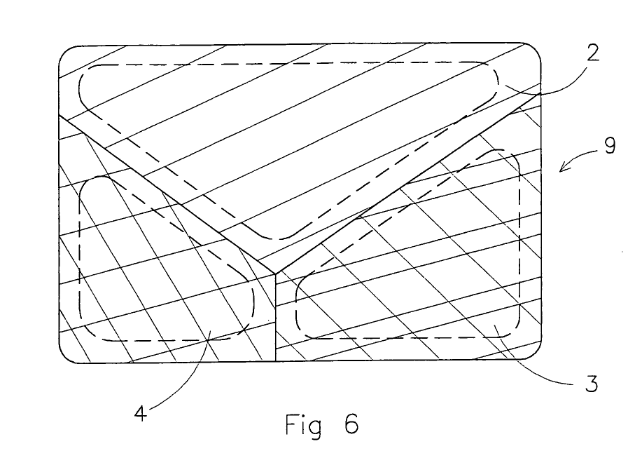

FIG. 6 shows the lid 9 in plan view, diagrammatically indicating the position of the compartments 2, 3 and 4. It will be clear that a material 12 which influences microwave radiation and is the same as material 7 is present in the section at compartment 3 of the lid 9.

Furthermore, different hatching in FIG. 6 diagrammatically indicates the possibility of providing a separate material which influences microwave radiation for each compartment, in such a manner that a different foodstuff which requires a different influence from microwave radiation can be prepared in each compartment.

It is often desirable for the cover to be locally provided with ventilation openings, as is generally known in microwaveable dishes of this type in order to discharge condensation. If one or more compartments are partially shielded by the presence of holes in the material which influences microwave radiation, it is preferably for ventilation openings of this type to coincide or be aligned with the pattern of holes in the material which influences microwave radiation. The fact that the ventilation openings are applied in advance prevents the user from damaging the material which influences microwave radiation. Obviously, when ventilation openings which are applied in advance are being used, an additional cover should be present, for hygiene reasons.

Finally, it should be noted that the microwaveable dish according to the invention may also be made suitable, by suitable selection of the materials, for what are known as combination ovens, a combination of a conventional oven and a microwave oven.

What is claimed is:

1. Microwaveable dish for supporting material which is to be treated in a microwave oven, in particular for foodstuffs to be prepared therein, which microwaveable dish comprises two or more compartments, a material which influences microwave radiation being incorporated in the wall of at least one of the compartments, allowing microwave radiation to be attenuated, amplified or converted into heat, and the wall comprising a plurality of layers, wherein the microwaveable dish comprises two identical, separately prefabricated self-supporting partial containers, one of the partial containers being at least partially accommodated in the other, and in that the material which influences microwave radiation is incorporated as a sheet-like material between the two partial containers.

2. Microwaveable dish according to claim 1, wherein the partial containers are self-supporting plastic partial containers.

3. Microwaveable dish according to claim 1, wherein the sheet-like material which influences microwave radiation comprises optionally supported aluminium foil.

4. Microwaveable dish according to claim 1, wherein the material which influences microwave radiation has a thickness in the range from 5-100 μm, preferably 6-20 μm.

5. Microwaveable dish according claim 1, wherein the microwaveable dish is a plate for foodstuffs.

6. Microwaveable dish according to claim 1, wherein the microwaveable dish also comprises a cover.

7. Microwaveable dish according to claim 6, wherein material which influences microwave radiation is also incorporated in the cover, allowing microwave radiation to be attenuated, amplified or converted into heat.

8. Microwaveable dish according to claim 1, wherein the partial containers are substantially identical.

9. Microwaveable dish according to claim 1, wherein at least one compartment is designed in such a manner that the microwave radiation can be attenuated, amplified or converted into heat to different extents at different positions in the said one compartment.

10. Microwaveable dish according to claim 1, wherein the microwave radiation can be substantially completely blocked in at least one compartment.

11. Microwaveable dish according to claim 1, wherein the partial containers are at least in part positioned at a distance from one another.

12. Microwaveable dish according to claim 11, wherein the partial containers are positioned at a distance from one another at least over their entire underside.

13. Microwaveable dish according to claim 11, wherein the distance is at least ≧0.5 mm.

14. Microwaveable dish according to claim 1, wherein the partial containers each have an encircling rim and are secured to one another at the encircling rims.

15. Microwaveable dish according to claim 1, which contains foodstuffs.

16. Partial container clearly intended for use in a microwaveable dish according to claim 1.

17. Use of a microwaveable dish according to claim 1 for preparing foodstuffs in a microwave oven.

18. Method for producing a microwaveable dish according to claim 1, in which one partial container is at least partially introduced into the other partial container with the sheet-like material which influences microwave radiation between them.

19. Method according to claim 18, wherein the two partial containers are secured to one another at least locally, preferably only at the encircling rims thereof, so as to form an insulating air gap between the partial containers.
